(19) United States
(12) Patent Application Publication
(10) Pub. No.: US 2008/0172626 A1
(43) Pub. Date: Jul. 17, 2008

(54) PORTABLE COMPUTER

(75) Inventor: Chi-Yu Wu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/838,234

(22) Filed: Aug. 14, 2007

(30) Foreign Application Priority Data
Jan. 16, 2007 (TW) 96101569

(51) Int. Cl. G06F 3/048; G09G 5/00

(52) U.S. Cl. 715/764; 345/1.1

(57) ABSTRACT

A portable computer is provided. The portable computer includes a main system and an auxiliary system. The main system includes a motherboard and a first display. The auxiliary system includes a second display and a microprocessor, wherein the microprocessor includes a general purpose input output (GPIO) interface and a display control bus. The microprocessor controls the main system through the GPIO interface.

### CROSS-REFERENCE TO RELATED APPLICATION

This application claims the priority benefit of Taiwan application serial no. 96101569, filed Jan. 16, 2007. All disclosure of the Taiwan application is incorporated herein by reference.

### BACKGROUND OF THE INVENTION

1. Field of the Invention

The invention relates to a portable computer and, more particularly, to a portable computer whose auxiliary system can control a main system.

2. Description of Related Art

Along with increasing demands of people about functions of portable computers, the design of portable computers changes with each passing day. Therefore, portable computers with various functions have been developed. Microsoft Corporation recently develops the double display configuration of portable computers, such as U.S. patent application Pub. Nos. 20060130072 and 20060250320. Microsoft Corporation develops a new operating system, Windows Vista, according to the configuration, and along with the operating system, many portable computer manufacturers also develop a new generation of portable computers.

The feature of the above portable computers is that both surfaces of their lids have a display, respectively. Microsoft Corporation offers various kinds of supports to such portable computers in its operating system, wherein many commercial, multimedia and system applications are included. The above applications can control a main system through an auxiliary display and an interface on the lid to, for example, play multimedia stored in hard disk or an optical storage medium, or inquiry E-mails or the electric quantity of a battery, without opening the lid of a portable computer. However, the above applications are relied on the power-on state of the computer. That is, a user can not do off-line operation about the above applications when the electricity of the portable computer is insufficient. Furthermore, the above applications are unable to control startup and shutdown. Therefore, the user still has to lift the lid and shut down the computer through shutdown option shown on the big display when starting up or shutting down the computer.

### BRIEF SUMMARY OF THE INVENTION

An objective of the invention is to provide a portable computer including a main system and an auxiliary system, which makes a user utilize the auxiliary system to control the main system without opening the lid of the portable computer.

To achieve the above and other objectives, the invention provides a portable computer. The portable computer includes a main system and an auxiliary system. The main system includes a motherboard and a first display, wherein the first display is coupled to the motherboard. The auxiliary system is coupled to the motherboard. The auxiliary system includes a second display and a microprocessor, wherein the microprocessor includes a general purpose input output (GPIO) interface and a display control bus. The display control bus is coupled to the second display. The GPIO interface is coupled to the motherboard. The microprocessor controls the main system through the GPIO interface.

According to the portable computer mentioned in the preferred embodiment of the invention, according to a startup signal, the above microprocessor simulates a power-on instruction of the main system for starting up the main system through the GPIO interface. According to a shutdown signal, the microprocessor simulates a power-off instruction of the main system through the GPIO interface. When the main system receives a power-off instruction, it makes itself enter a standby or shutdown state according to a system state. In one preferred embodiment of the invention, the microprocessor further includes a system management bus (SMbus) and a universal serial bus (USB), and is coupled to the motherboard through the SMbus and the USB. Data transmission between the main system and the auxiliary system can be carried out through the USB, and reading battery capacity can be carried out through the SMbus.

The portable computer configuration in the embodiment of the invention is to couple a main system with an auxiliary system through a GPIO interface. Therefore, when using the auxiliary system, a user can control the main system through the GPIO interface to start up, or to enter a standby or shutdown state, and so on. Furthermore, in the embodiment of the invention, the user may browse electrical messages, play multimedia, and also know the present main system state of the portable computer, such as whether a power input plug is plugged in or the endurance of the battery, through the auxiliary system. Therefore, the portable computer in the embodiment of the invention can make the auxiliary system control the main system, whereby operating usage is much simple and convenient.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a block diagram showing the circuit of the portable computer according to one embodiment of the invention.

FIG. 2 is a block diagram showing the circuit of the portable computer according to another embodiment of the invention.

FIG. 3 is block diagram showing the operating system of the portable computer according to another embodiment of the invention.

### DETAILED DESCRIPTION OF THE INVENTION

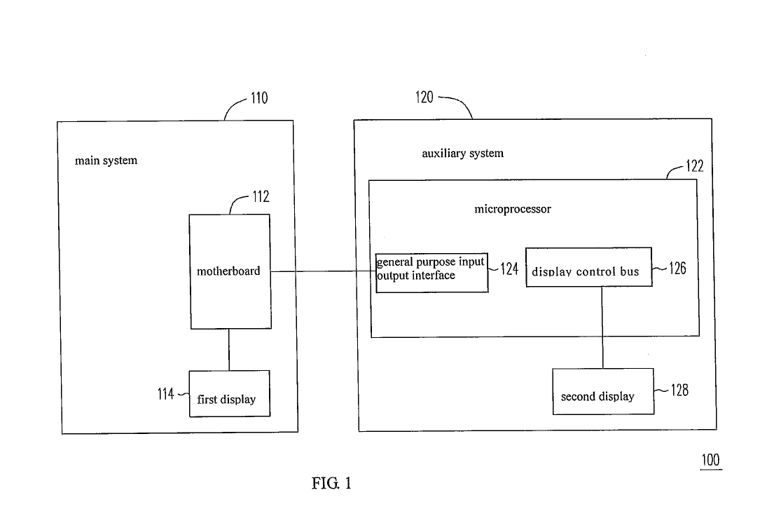

FIG. 1 is a block diagram showing the circuit of the portable computer according to one embodiment of the invention. As shown in FIG. 1, the portable computer 100 includes a main system 110 and an auxiliary system 120. The main system 110 includes a motherboard 112 and a first display 114. The auxiliary system 120 includes a second display 128 and a microprocessor 122, wherein the microprocessor 122 includes a general purpose input output (GPIO) interface 124 and a display control bus 126.

In the embodiment, the portable computer 100 maybe a notebook, a tablet personal computer (PC), a palmtop PC, or an ultra-mobile personal computer (UMPC).

The above first display 114 is coupled to the motherboard 112, and the motherboard 112 is also coupled to the microprocessor 122 and the second display 128, respectively. The microprocessor 122 is coupled to the second display 128 through the display control bus 126, and to the motherboard 112 through the GPIO interface 124 for controlling the main system 110. The following illustrates embodiment of the invention with the above elements.

First, when wanting to start up the portable computer 100, a user needs only to send an instruction to the microprocessor 122 without opening the lid which is closed. And then, the microprocessor 122 may send out a signal through the GPIO interface 124 for controlling the motherboard 112 to execute startup action. Taking the power supplying mechanism of common X86 as an example, the microprocessor 122 may be coupled to the power button of the motherboard 112 through the GPIO interface 124, and the above signal may be, for example, a startup pulse for simulating a user's pressing the power button.

The above startup mode that the auxiliary system 120 controls the main system 110 is more rapid than that after lifting the lid. Furthermore, in the embodiment, when the main system 110 is started up with the lid of the computer closed, pictures are only shown on the second display 128. Because of being the auxiliary display of the first display 114, the second display 128 may be much smaller than the first display 114. During the startup with the lid of the computer closed, the backlight of the big display 114 which needs not to be driven, is unnecessary to be lightened; therefore, indicating startup messages by the small display 128 saves more electricity than that by the big display 114.

Going on referring to FIG. 1, in the operation of another embodiment, a user may deal with words editing, verbal reports, images processing, and so on, through the operating system built-in in the main system 110. A user may close the lid of the computer and rest after finishing work. At the moment, the user may use the auxiliary system 120, and may also shut down the main system 110 first and keep the auxiliary system 120 working according to the demand of the user. The user may send out an instruction from the auxiliary system 120 to the microprocessor 112 for shutting down the main system 110. When the microprocessor 122 receives a shutdown signal, it simulates the power-off instruction of the main system 110 through the GPIO interface 124. Generally speaking, the interior of the main system 110 usually has a few setting values about the power-off instruction, for example, the basic input/output system (BIOS) of a common X86 computer usually has a special setting value corresponding to pressing a power button, and the setting value usually has at least two definitions that one is a standby state and the other is a shutdown state. When the motherboard 112 receives the power-off instruction, it makes the main system 110 enter the standby or shutdown state according to the above setting value.

Surely, when the main system 110 and the auxiliary system 120 work at the same time, a user may shut down both systems through the auxiliary system 120. Especially, when it is unnecessary to operate the auxiliary system 120, the user may shut down the main system 110 and the auxiliary system 120, or only shut down the auxiliary system 120. The user need not open the lid of the computer again. The user may send an instruction for shutting down one or both systems through the auxiliary system 120. Taking shutting down both systems as an example, the microprocessor 122 controls the main system 110 to shut down through the GPIO interface 124, and then shuts down the auxiliary system 120, after which the process of shutting down both systems is accomplished.

Referring to the above embodiment, persons having ordinary skill in the art may appreciate that the mode that the auxiliary system 120 controls the main system 110 in the embodiment is much convenient and rapid in usage. Especially when using the auxiliary system 120 for shutdown or startup, a user need not open the lid of the computer, which saves time of the user. Another advantage is that the auxiliary system 120 can be operated and used independently when the main system 110 is shut down. Therefore, applying the circuit configuration of the above embodiment, the auxiliary system 120 controls the main system 110 through the GPIO interface. On the other hand, this mode of startup or shutdown much meets the expected psychological demand of a user, and saves unnecessary power consumption whereby extending the endurance of a battery.

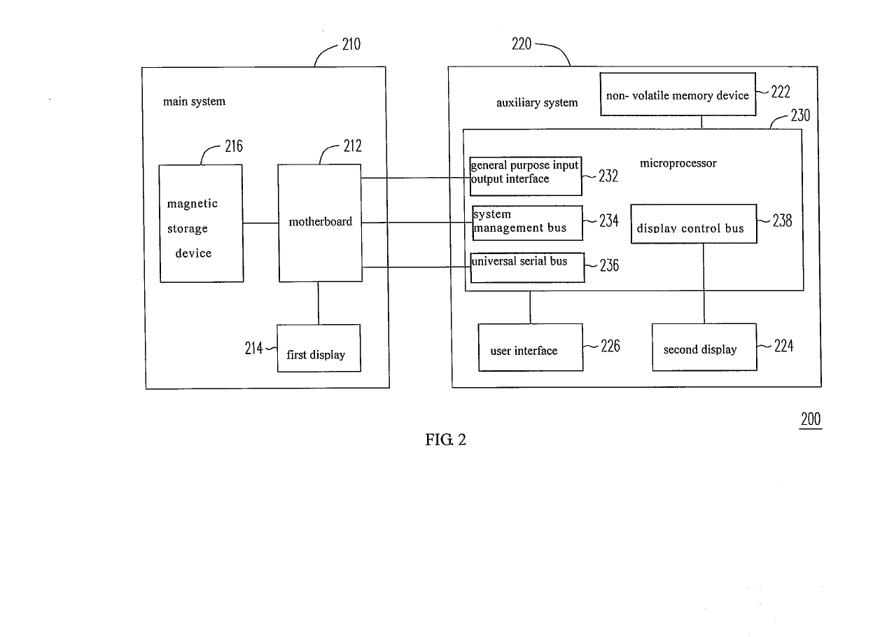

FIG. 2 is block diagram showing the circuit of a portable computer according to another embodiment of the invention. Please refer to FIGS. 1 and 2 at the same time, and the portable computer 200 in FIG. 2 includes a main system 210 and an auxiliary system 220. The main system 210 includes a motherboard 212, a first display 214, and a magnetic storage device 216. The auxiliary system 220 includes a second display 224, a microprocessor 230, a user interface 226, and a non-volatile memory (NVM) device 222, wherein the microprocessor 230 includes a general purpose input output (GPIO) interface 232, a system management bus (SMBus) 234, a universal serial bus (USB) 236, and a display control bus 238. The configuration difference between the portable computer 200 in FIG. 2 and the portable computer 100 in FIG. 1 is that the portable computer 200 includes the magnetic storage device 216, the NVM device 222, the user interface 226, the SMBus 234, and the USB 236, additionally.

The above motherboard 212 is coupled to the first display 214 and the magnetic storage device 216, and also to the microprocessor 230, the second display 224, the user interface 226, and the NVM device 222, respectively. Wherein the microprocessor 230 is coupled to the second display 224 through the display control bus 238, and controls the second display 224. The microprocessor 230 is coupled to the motherboard 212 through the GPIO interface 236, the SMBus 234, and the USB 236, wherein the microprocessor 230 controls the main system 210 through the GPIO interface 236. Furthermore, data transmission between the main system 210 and the auxiliary system 220 is carried out through the USB 236. The following goes on illustrating the embodiment of the invention with the above elements.

Generally speaking, the magnetic storage device 216 may be a hard disk with high capacity. The microprocessor 230 is coupled to the motherboard 212 through the USB 236; therefore, the microprocessor 230 can acquire data stored in the magnetic storage device 216 through the USB 236 and the motherboard 212. When the main system 210 and the auxiliary system 220 of the portable computer 200 are both in the on state, electronic message data, multimedia data, and so on, stored in the magnetic storage device 216 can be rapidly transmitted through the USB 236, of the microprocessor.230. Moreover, these data may be stored in the NVM 222.

Referring to the above embodiment, the main system 210 may further include a plug and play memory device. Persons having ordinary skill in the art may store data of the plug and play memory device into the NVM device 222 through the USB 236. Therefore, when the main system 210 of the portable computer 200 is shut down, a user can still read electronic messages, view pictures, or play music by the auxiliary system 220. Therefore, the user can get data stored in the hard disk of the main system 210 unlike the past mode that must start up the motherboard, the central processing unit (CPU), and the peripheral hard disk.

Furthermore, because the NVM device 222 in FIG. 2 is applied to the portable computer 200, its characteristics about small volume, large capacity, light weight, non-volatility and shakeproof performance, and so on, must be considered. The preferred embodiment of the NVM device 222 is to adopt a nand flash memory. Therefore, if the NVM device 222 adopts the nand flash memory, it can act as the storage medium of the auxiliary system 220 for storing much data. And when the power is off, the user never needs to worry about losing data stored in the nand flash memory.

Referring to the above embodiment, persons having ordinary skill in the art can know that the auxiliary system 220 may further include a dynamic random access memory (DRAM). The efficiency of the DRAM is to temporarily store working data of the microprocessor 230, and to avoid reading data too slowly for the unsteady system caused by the portable computer 200 which is used in a shaky environment, such as during movement or unsteady operation on a knee. The DRAM temporarily stores particular data used by the auxiliary system 220, and this makes the work of the auxiliary system 220 be much smooth.

As mentioned above, the user interface 226 in FIG. 2 provides an operating interface, and when it is operated with the functional option shown in the second display 224, a user may intuitively select data stored in the NVM device 222 for application. The user interface 226 may be a control panel or a multi-functional option key. When the shown functional option is selected and enabled, a signal may be produced and transmitted to the microprocessor 230. The microprocessor 230 receives the signal and operates according to the signal. Taking transmitting a startup signal to the microprocessor 230 from the user interface 226 as an example: the microprocessor 230 simulates a power-on instruction of the main system 210 according to the startup signal; and then, the power-on instruction is transmitted to the motherboard 212 through the GPIO interface 232; and subsequently, the main system 210 is started up. Or, taking transmitting a shutdown signal to the microprocessor 230 from the user interface 226 as an example: the microprocessor 230 simulates a power-off instruction of the main system 210 according to the shutdown signal; and then, the power-off instruction is transmitted to the motherboard 212 through the GPIO interface 232; and subsequently, the main system 210 receives the power-off instruction and makes itself enter a standby or shutdown state according to its operating system state.

The microprocessor 230 in FIG. 2 can be coupled to the main system 210 through the GPIO interface 232, know the state of the main system 210, and know whether the present power is supplied by a battery or power network. Moreover, the microprocessor 230 can read battery capacity through the SMBus 234.

The microprocessor 230 controls the picture rotary angle of the second display 224 through the display control bus 238. For example, the basic input output system (BIOS) of the computer sets the picture rotary angle of the display 224 be 0 degree when the lid of the computer is closed. The BIOS sets the picture rotary angle of the second display 224 be 180 degrees when the lid of the computer is opened. In this way, a user may sense a normal display about the picture shown in the second display 224.

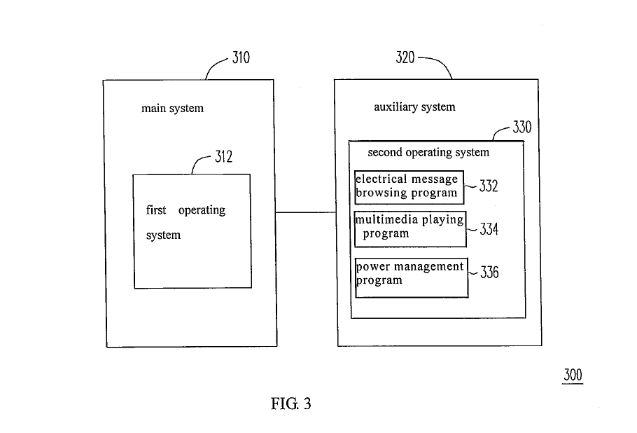

The embodiment of the invention in some circumstances may utilize two operating systems in the circuit configuration shown in FIG. 2. FIG. 3 is a block diagram showing the operating system of the portable computer according to another embodiment of the invention. The magnetic storage device of the main system 310 in FIG. 3 stores a first operating system 312. The NVM device of the auxiliary system 320 stores a second operating system 330, wherein the second operating system 330 includes an electrical message browsing program 332, a multimedia playing program 334, and a power management program 336. The content of the first operating system 312 is shown on the first display of the above embodiment, and the content of the second operating system 330 is shown on the second display of the above embodiment. The auxiliary system 320 is coupled to the main system 310, and the connection between the two systems and that between the system and the display include the GPIO interface, SMBus, the USB, and the display control bus, mentioned in the above embodiment.

First, the power management program 336 of the second operating system 330 can make the microprocessor of the above embodiment simulate the power-on instruction of the main system 310 according to a startup signal. The power-on instruction is transmitted to the motherboard through the GPIO interface and the main system is started up. The power management program 336 may also make the microprocessor simulate the power-off instruction of the main system 310 according to a shutdown signal. After receiving the power-off instruction from the auxiliary system 320, the main system 310 makes itself enter a standby or shutdown state according to the system state of the first operating system 312. The power management program 336 may also make the microprocessor know, through the GPIO interface, the power is supplied by a battery or power network. The power management program 336 may also make the microprocessor read battery capacity through the SMBus. Therefore, a user may know the present power state of the portable computer 300 through the power management program 336.

Next, if the main system 310 is in the off state, the NVM device provides reading and storing functions for working data of the auxiliary system 320. The multimedia playing program 334 of the second operating system 330 can make the microprocessor of the above embodiment play multimedia data stored in the NVM device, for example, playing music, pictures, or video files. Furthermore, the electrical message browsing program 332 makes the microprocessor continually read lately downloaded emails or electron faxes, etc. and store them to the NVM device by refreshing, when the main system 310 and the auxiliary system 320 are both working. Taking the circumstance that the main system 310 is shut down as an example, when wanting to read emails in an off-line state, a user can operate the electrical message browsing program 332 of the second operating system 330 to do that. Because the latest electrical messages can be read from the NVM device, the user may see the latest electrical messages downloaded before on the small display of the auxiliary system 320.

To sum up, the configuration of the portable computer in the embodiment of the invention utilizes a GPIO interface to couple a main system and an auxiliary system. Therefore, when using the auxiliary system, a user may control the main system to start up, enter a standby or shutdown state, and so on, through the GPIO interface. Therefore, the portable computer in the embodiment of the invention can control the main system through the auxiliary system, and this makes operation and usage much simple and convenient.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A portable computer, comprising:
a main system comprising:
a motherboard; and
a first display coupled to the motherboard; and
an auxiliary system coupled to the motherboard, and the auxiliary system comprising:
a second display; and
a microprocessor comprising a general purpose input output (GPIO) interface and a display control bus, wherein the display control bus is coupled to the second display, the GPIO interface is coupled to the motherboard, and the microprocessor controls the main system through the GPIO interface.

2. The portable computer according to claim 1, wherein the microprocessor simulates a power-on instruction of the main system for starting up the main system through the GPIO interface according to a startup signal.

3. The portable computer according to claim 1, wherein the microprocessor simulates a power-off instruction of the main system through the GPIO interface according to a shutdown signal, and the main system receives the power-off instruction and makes itself enter a standby or shutdown state according to a system state.

4. The portable computer according to claim 1, wherein the microprocessor further comprises a system management bus (SMbus) through which the microprocessor is coupled to the motherboard.

5. The portable computer according to claim 1, wherein the microprocessor further comprises a universal serial bus (USB) through which the microprocessor is coupled to the motherboard.

6. The portable computer according to claim 1, wherein the auxiliary system further comprises a user interface (UI) providing an operating interface for a user.

7. The portable computer according to claim 4, wherein the microprocessor reads battery capacity through the SMbus.

8. The portable computer according to claim 5, wherein data transmission between the main system and the auxiliary system is carried out through the USB.

9. The portable computer according to claim 1, wherein the main system comprises a magnetic storage device which stores a first operating system and the auxiliary system comprises a non-volatile memory (NVM) device which stores a second operating system.

10. The portable computer according to claim 9, wherein the second operating system comprises an electrical message browsing program, a multimedia playing program, and a power management program.

11. The portable computer according to claim 1, wherein the microprocessor controls a picture rotary angle of the second display through the display control bus.
